(19) United States
(12) Patent Application Publication
(10) Pub. No.: US 2026/0229386 A1
(43) Pub. Date: Aug. 6, 2026

(54) HIGH-SPEED CABLE AND CABLE UNIT STRUCTURE THEREOF

(71) Applicant: ZHEJIANG ZHAOLONG INTERCONNECT TECHNOLOGY CO., LTD., ZHEJIANG (CN)

(72) Inventors: Duanxi ZHOU, ZHEJIANG (CN); Donghua NI, ZHEJIANG (CN); Dequan WANG, ZHEJIANG (CN); Youshuai GENG, ZHEJIANG (CN); Senhui FENG, ZHEJIANG (CN)

(21) Appl. No.: 19/094,781

(22) Filed: Mar. 28, 2025

(30) Foreign Application Priority Data
Feb. 5, 2025 (CN) 202520189471.5

(51) Int. Cl. H01B 7/18

(52) U.S. Cl. CPC H01B 7/1875

(57) ABSTRACT

A cable unit structure includes two cable cores, a low dielectric material layer, an inner shielding layer and an outer cladding layer. The cable cores are arranged parallel to each other, each including an inner conductor and an insulation layer covering the inner conductor; the low dielectric material layer wraps two cable cores using a wrapping method; the inner shielding layer covers the low dielectric material layer; the outer cladding layer includes an insulative adhesive layer and a copper or aluminum layer and uses the copper or aluminum layer located inside and the insulative adhesive layer located outside to cover the inner shielding layer using a crossover method, and the insulative adhesive layer is formed by a heat-melt polyethylene terephthalate or polypropylene tape layer. In this way, the cable unit structure has excellent structural strength and the effects of shielding electromagnetic signals and blocking electromagnetic leakage.

### BACKGROUND OF THE DISCLOSURE

### Technical Field

The present disclosure relates to a cable structure, particularly relates to a high-speed cable and a cable unit structure thereof.

### Description of Related Art

Data transmission cable is an important carrier to realize data signal transmission and exchange, so with the continuous development of data network, the research and development of cable products are also facing new technological changes and innovations, on the one hand, to improve the transmission rate, to meet the large-capacity information transmission and exchange, and on the other hand, to improve the transmission stability, improve the quality of information transmission.

Among them, parallel biaxial copper cables in data transmission cables with the advantages of high speed, low latency, small size and low cost are widely used in communication transmission, data centers, information services and other fields to satisfy the high-speed transmission and exchange of large-capacity audio, video, image and other data signals.

The aforementioned parallel biaxial cable consists of a plurality of unit structures arranged parallel to each other, and each unit structure has two parallel insulated single wires, an outer cladding layer, and a shielding layer covering the two parallel insulated single wires. The outer cladding and shielding layer are used to shield the external electromagnetic signals and at the same time block the electromagnetic leakage of the cables for maintaining the stability of the transmission network.

However, the related-art cladding layers only use a single layer of hot melt polyethylene terephthalate or polypropylene tape, and the shielding layer only uses a single layer of aluminum foil or a single layer of copper foil, where the shielding attenuation of a single layer of aluminum foil is relatively large, and the single layer of hot melt polyethylene terephthalate or polypropylene tape or a the single layer of copper foil has poor resistance to bending and is prone to breaking, which reduces the shielding efficiency of the shielding layer for shielding electromagnetic signals from the outside and the effect of blocking electromagnetic leakage.

In view of the deficiencies of the related art, the present discloser conducted researches based on the existing technologies and the application of theories, and finally developed the high-speed cable and the cable unit structure thereof in accordance with the present disclosure to overcome the deficiencies of the related art.

### SUMMARY OF THE DISCLOSURE

The present disclosure provides a high-speed cable and a cable unit structure thereof, which utilizes an outer cladding layer consisting of a copper or aluminum layer located inside and an insulative adhesive layer located outside which covers an inner shielding layer in a crossover manner and an insulative adhesive layer is made of heat-melt polyethylene terephthalate or polypropylene to produce the cable unit structure with excellent structural strength, and achieve the effect of shielding external electromagnetic signals and the efficiency of blocking electromagnetic leakage.

In an embodiment of the present disclosure, a cable unit structure is provided, which includes: two cable cores, arranged parallel to each other, each of the cable cores including an inner conductor and an insulation layer covers the inner conductor; a low dielectric material layer, covering the two cable cores by a wrapping method; an inner shielding layer, covering the low dielectric material layer; and an outer cladding layer including an insulative adhesive layer and a copper or aluminum layer, the outer cladding layer covering the inner shielding layer by utilizing the copper or aluminum layer located inside and the insulative adhesive layer located outside in a crossover manner, and the insulative adhesive layer being formed by a heat-melt polyethylene terephthalate or polypropylene tape layer.

In an embodiment of the present disclosure, the present disclosure provides a high-speed cable, including: at least two cable unit structures arranged parallel to each other, each of the cable unit structures including: two cable cores, arranged parallel to each other, each of the cable cores including an inner conductor and an insulation layer covering the inner conductor; a low dielectric material layer wrapping the two cable cores using a wrapping method; an inner shielding layer, covering the low dielectric material layer; and an outer cladding layer, including an insulative adhesive layer and a copper or aluminum layer, the outer cladding layer covering the inner shielding layer by utilizing the copper or aluminum layer located inside and the insulative adhesive layer located outside in a crossover manner, and the insulative adhesive layer being formed by a heat-melt polyethylene terephthalate or polypropylene tape layer.

Based on the above, the present disclosure adopts the outer cladding layer to wrap the inner shielding layer in a crossover manner by utilizing the copper or aluminum layer located inside and the insulative adhesive layer located outside, the insulative adhesive layer is formed by the heat-melt polyethylene terephthalate or polypropylene tape layer, the two crossed layers including the insulative adhesive layer and the copper or aluminum layer enhance the structural strength and the resistance against bending and damaged, and the copper or aluminum layer reduces the shielding attenuation, so as to produce the cable unit structure with desirable structural strength, and achieve the effect of shielding external electromagnetic signals and the efficiency of blocking electromagnetic leakage.

### BRIEF DESCRIPTION OF THE DRAWINGS

FIG. 1 is a perspective view of a cable unit structure in accordance with a first embodiment of the present disclosure.

FIG. 2 is a cross-sectional view of a composite shielding layer in accordance with the first embodiment of the present disclosure.

FIG. 3 is a cross-sectional view of a cable unit structure in accordance with the first embodiment of the present disclosure.

FIG. 4 is a cross-sectional view of a low dielectric material layer covering two cable cores by a wrapping method in accordance with the first embodiment of the present disclosure.

FIG. 5 is a cross-sectional view of a high-speed cable in accordance with the first embodiment of the present disclosure.

FIG. 6 is a cross-sectional view of a high-speed cable of a second embodiment of the present disclosure.

FIG. 7 is a cross-sectional view of a cable unit structure in accordance with the second embodiment of the present disclosure.

FIG. 8 is a cross-sectional view of a cable unit structure in accordance with a third embodiment of the present disclosure.

FIG. 9 is a cross-sectional view of a cable unit structure in accordance with a fourth embodiment of the present disclosure.

FIG. 10 is a cross-sectional view of a cable unit structure in accordance with a fifth embodiment of the present disclosure.

FIG. 11 is a cross-sectional view of a cable unit structure in accordance with a sixth embodiment of the present disclosure.

FIG. 12 is a cross-sectional view of a cable unit structure in accordance with a seventh embodiment of the present disclosure.

### DETAILED DESCRIPTION

The detailed description and technical contents of the present disclosure are illustrated with reference to the accompanying drawings, which are intended for the illustrative purposes only, but not intended for limiting the disclosure.

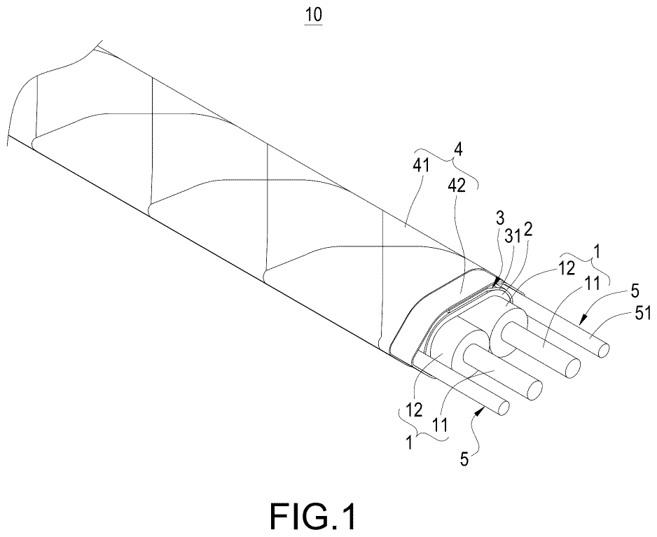

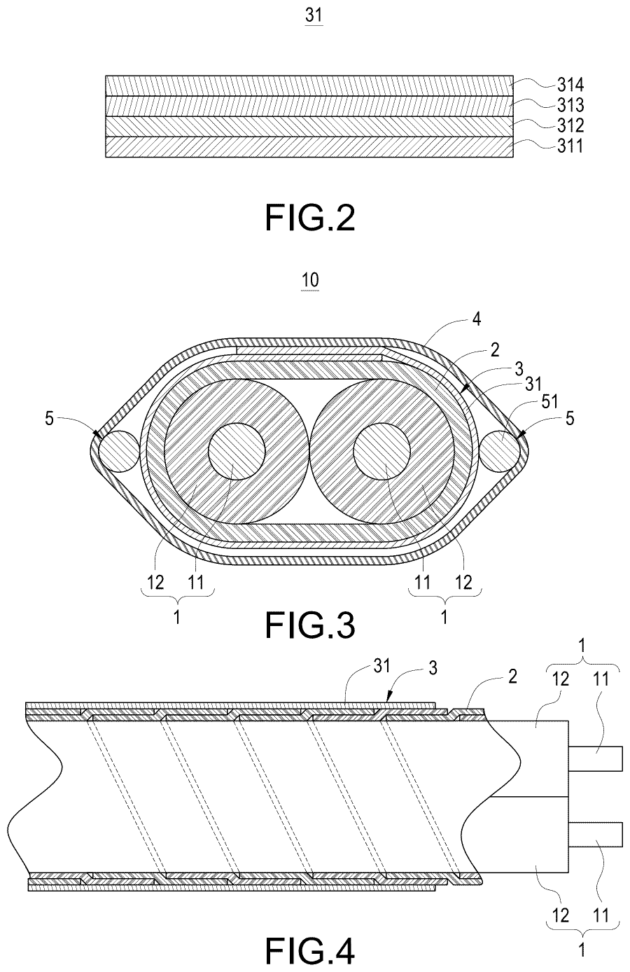

With reference to FIGS. 1 to 5, the present disclosure provides the first embodiment of a high-speed cable and a cable unit structure thereof, the high-speed cable mainly includes two or more cable unit structures 10, the cable unit structure 10 mainly includes two cable cores 1, a low dielectric material layer 2, an inner shielding layer 3 and two outer cladding layers 4.

As shown in FIGS. 1, 3 and 4, the two cable cores 1 are arranged parallel to each other, each cable core 1 includes an inner conductor 11 and an insulation layer 12 covering the inner conductor 11 by extrusion, and the low dielectric material layer 2 covers the two cable cores 1 by a high-speed wrapping device using a wrapping method.

The details are as follows. As shown in FIG. 4, the wrapping overlap rate of the low dielectric material layer 2 is equal to or greater than 40% and equal to or less than 70%, that is, the low dielectric material layer 2 located at the upper layer covers the width of the low dielectric material layer 2 located at the lower layer with a range of equal to or greater than 40% and equal to or less than 70%, and the wrapping overlaps the low dielectric material layer 2 by 2 or 3 layers to ensure that the appearance of the cable unit structure 10 is round and smooth, and the low dielectric material layer 2 is made of expanded polytetrafluoroethylene (ePTFE) or polytetrafluoroethylene (PTFE), and the thickness of the low dielectric material layer 2 is equal to or greater than 0.02 mm and equal to or less than 0.12 mm.

In addition, the dielectric constant of related-art PTFE materials is generally 2.1, and the dielectric constant of related-art ePTFE materials generally reaches 1.4, thereby greatly reducing the dielectric constant of the tape, causing the cable unit structure 10 to be smaller than the general size, and resulting in better attenuation performance and softer cable.

As shown in FIGS. 1 to 4, the inner shielding layer 3 covers the low dielectric material layer 2, and the inner shielding layer 3 of this embodiment is a composite shielding layer 31 covering the low dielectric material layer 2 in a manner of concentrical wrapping and longitudinal covering. The composite shielding layer 31 is formed by sequentially stacking a hot melt adhesive layer 311, a copper or aluminum layer 312, a conductive adhesive layer 313 and an aluminum layer 314 in a direction away from the low dielectric material layer 2, and the composite shielding layer 31 adopts a longitudinal covering method to concentrically cover the low dielectric material layer 2 to achieve the effect of supporting a larger bandwidth than that using the related-art wrapping method. The longitudinal covering bandwidth of the composite shielding layer 31 of the present disclosure reaches 40 GHz or higher.

However, the inner shielding layer 3 is not limited to the composite shielding layer 31, and the inner shielding layer 3 may be a copper or aluminum layer (not shown in the figures), covering the low dielectric material layer using a concentrical wrapping and longitudinal covering method; or the inner shielding layer 3 includes two copper or aluminum layers (not shown in the figures), one of the copper or aluminum layers covers the low dielectric material layer 2 using the concentrical wrapping and longitudinal covering method, and the other copper or aluminum layer covers one of the copper or aluminum layers using the wrapping method to provide a more impact structure.

As shown in FIG. 1, the outer cladding layer 4 includes an insulative adhesive layer 41 and a copper or aluminum layer 42, the insulative adhesive layer 41 is formed by a heat-melt polyethylene terephthalate (PET) or polypropylene (PP) tape layer, the outer cladding layer 4 covers the inner shielding layer 3 with a copper or aluminum layer 42 located inside and an insulative adhesive layer 41 located outside in a crossover manner, and the two crossed layers: the copper or aluminum layer 42 located inside and the insulative adhesive layer 41 located outside have a cross covering overlap rate of greater than 25%, that is, the insulative adhesive layer 41 located at the upper layer covers greater than 25% of the copper or aluminum layer 42 located at the lower layer.

As shown in FIG. 3, the cable unit structure 10 of the present disclosure further includes one or more drain wires 5, there are two drain wires 5 in this embodiment, each of the drain wires 5 is a cylindrical conductor 51 with a circular cross-section, the drain wire 5 is clamped between the inner shielding layer 3 and the outer cladding layer 4 and arranged on the left and right sides of the two cable cores 1 which are arranged on the left and right sides relative to each other, and parallel to each other.

The detailed description is as follows: The drain wire 5 is provided for grounding, and the contact surface between the inner shielding layer 3 and the drain wire 5 is smooth and flat, so that when the cable unit structure 10 is subjected to subsequent processing such as wrapping the outer sheath, the contact surface between the inner shielding layer 3 and the drain wire 5 is not easy to be wrinkled, so that the shielding effect of the inner shielding layer 3 may not be affected, and the drain wire 5 mainly plays the role of grounding and tensile resistance. In good and correct grounding conditions, the inner shielding layer 3 blocks the electromagnetic leakage of the cable itself and shields external electromagnetic signals, so that the cable unit structure 10 of the present disclosure achieves a full range of shielding effects for internal and external signals.

In some embodiments, the inner conductor 11 is made of bare copper, plated copper or plated alloy copper, the insulation layer 12 is made of fluoroplastic or polyolefin material, and includes but is not limited to any one of the fluorinated ethylene propylene (FEP) material, foamed fluoroplastic, polyethylene (PE) material, and foamed PE material, and the drain wire 5 is a bare copper wire, plated copper wire or alloy copper wire.

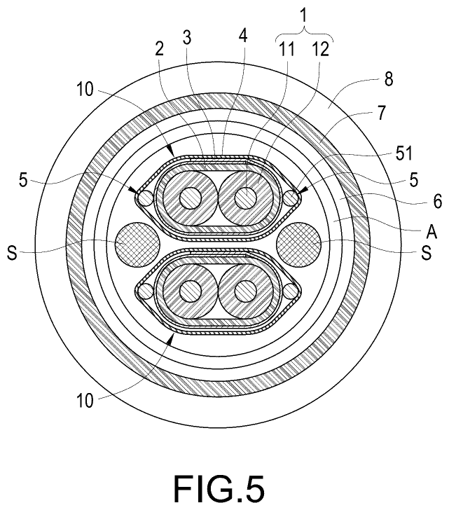

With reference to FIG. 5 for the high-speed cable in accordance with this embodiment of the present disclosure, there are two cable unit structures 10 arranged parallel to each other, and the high-speed cable of this embodiment further includes a first tape layer A, an outer shielding layer 6, a braiding layer 7, an external layer 8 and two spacers S. The first tape layer A, outer shielding layer 6, braiding layer 7 and external layer 8 are sequentially arranged from inside to outside and cover the two cable unit structures 10, and the two spacers S are clamped between the two cable unit structures 10 and the first tape layer A, so as to provide the high-speed cable with an impact structure and a round and smooth appearance.

In some embodiments, the first tape layer A is a protective layer made of polyester tape, PP tape, non-woven fabric, or PI tape material, the outer shielding layer 6 is made of aluminum foil, copper foil, or copper-aluminum composite tape material, and the metal surface of the outer shielding layer 6 is configured to face outward, that is, the metal surface of the outer shielding layer 6 is configured to face the direction away from the two cable cores 1, the braiding layer 7 is made of tinned copper wire, aluminum-magnesium wire or tinned copper-clad steel wire, the external layer 8 is a protective covering layer, the external layer 8 is made of plastic material by extrusion such as PVC extrusion, LSZH extrusion, TPE extrusion, TPU extrusion or woven with PET wire and other materials, the spacer S is cotton thread or PP hemp, the spacer S is used to make the cable unit structure 10 round, so in some embodiments, the spacer S is omittable.

Only a single layer of the heat-melt polyethylene terephthalate or polypropylene tape layer is used in the related-art outer cladding layer, but such single layer of the heat-melt polyethylene terephthalate or polypropylene tape layer has poor bending resistance and is prone to break easily. In contrast, the present disclosure adopts the outer cladding layer 4 which covers the inner shielding layer 3 with the copper or aluminum layer 42 located inside and the insulative adhesive layer 41 located outside, and the insulative adhesive layer 41 is formed by the heat-melt polyethylene terephthalate or polypropylene tape layer, so that the two crossed layers: the insulative adhesive layer 41 and the copper or aluminum layer 42 enhance the structural strength and the resistance against bending and damaged, and the copper or aluminum layer reduces the shielding attenuation, so as to produce the cable unit structure with desirable structural strength, and achieve the effect of shielding external electromagnetic signals and the efficiency of blocking electromagnetic leakage.

In addition, only a single layer of aluminum foil or a single layer of copper foil is used in the related-art shielding, but the attenuation of the single layer of aluminum foil shielding is large, and the single layer of copper foil has poor bending resistance and is prone to breakage. In contrast, when the inner shielding layer 3 of the present disclosure is a composite shielding layer 31, the composite shielding layer 31 is formed by sequentially stacking a hot melt adhesive layer 311, a copper or aluminum layer 312, a conductive adhesive layer 313 and an aluminum layer 314 in a direction away from the low dielectric material layer 2. The conductive adhesive layer 313 mainly allows the double-layer copper or aluminum layer 312 to be bonded to the aluminum layer 314 to achieve the two metal layers of the copper or aluminum layer 312 and the aluminum layer 314 to be conductive. The double-layer copper or aluminum layer 312 and the aluminum layer 314 reduce shielding attenuation, increase structural strength, resist bending, and prevent easy breakage. The hot melt adhesive layer 311 also increases structural strength, resist bending, and prevent easy breakage, so that the cable unit structure 10 has desirable structural strength, the effect of shielding external electromagnetic signals, and the efficiency of blocking electromagnetic leakage.

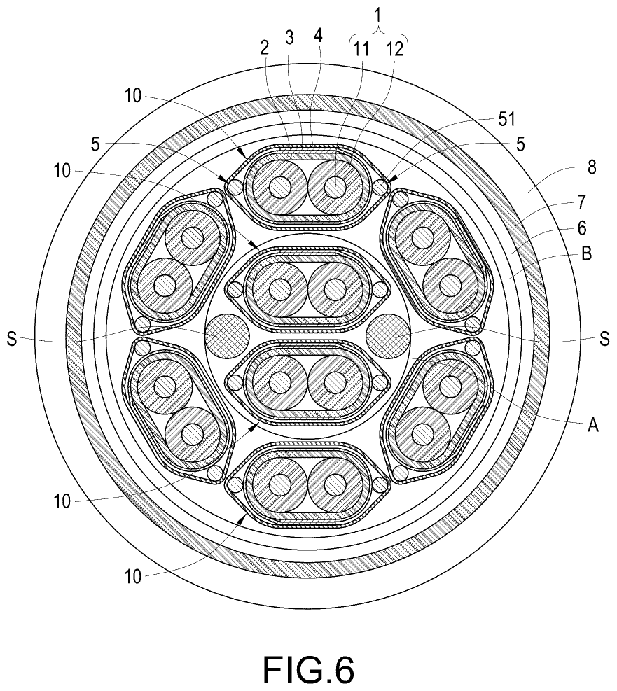

With reference to FIG. 6 for a high-speed cable in accordance with the second embodiment of the present disclosure, this embodiment is substantially the same as the first embodiment as shown in FIGS. 1 to 5, except that the high-speed cable of this embodiment further includes a first tape layer A, a second tape layer B, an outer shielding layer 6, a braiding layer 7, an external layer 8 and two spacers S, and there are eight cable unit structures 10.

Further detailed description is as follows: the two cable unit structures 10 of this embodiment are arranged at top and bottom relative to each other and parallel to each other, the first tape layer A covers the two cable unit structures 10, the remaining fix cable unit structures 10 equidistantly wind around the two cable unit structures 10 and the first tape layer A. The second tape layer B, outer shielding layer 6, braiding layer 7 and external layer 8 sequentially wrap around the eight cable unit structures 10, the two spacers S are clamped between the two cable unit structures 10 and the first tape layer A, so that the high-speed cable achieves a compact structure and a round and smooth appearance. The second tape layer B and the first tape layer A are protective layers, and the second tape layer B is made of polyester tape, PP tape, non-woven fabric, or PI tape materials.

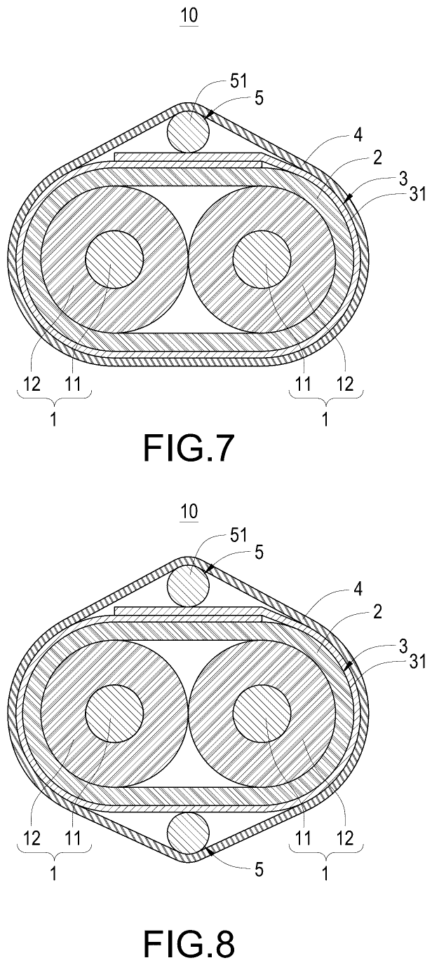

With reference to FIGS. 7 and 8 for the cable unit structures 10 of the second and third embodiments of the present disclosure respectively, the second and third embodiments are substantially the same as the first embodiment as shown in FIGS. 1 to 4, except that the cylindrical conductor 51 of these embodiments is located at a different location.

The detailed description is as follows: there is one drain wire 5 in the second embodiment, that is, there is one cylindrical conductor 51 clamped between the inner shielding layer 3 and the outer cladding layer 4 and configured at the upper side of the two cable cores 1 which are arranged side by side with each other; there are two drain wires 5 in the third embodiment, that is, there are two cylindrical conductors 51 respectively clamped between the inner shielding layer 3 and the outer cladding layer 4 and configured on the upper and lower sides of the two cable cores 1 which are arranged side by side with each other.

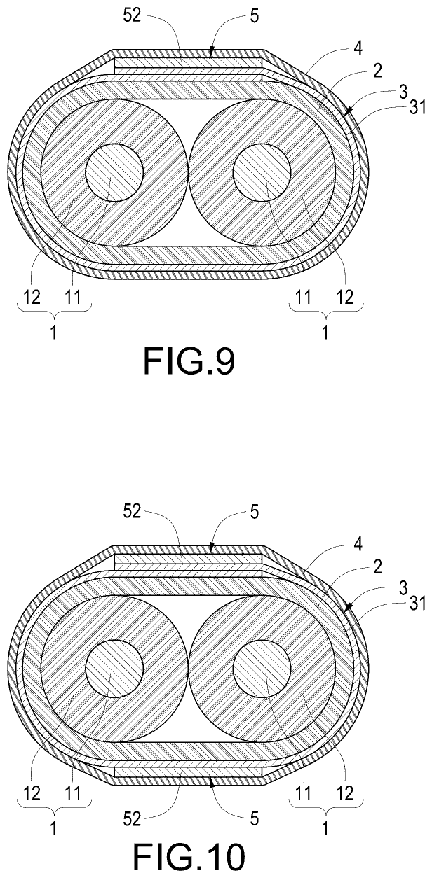

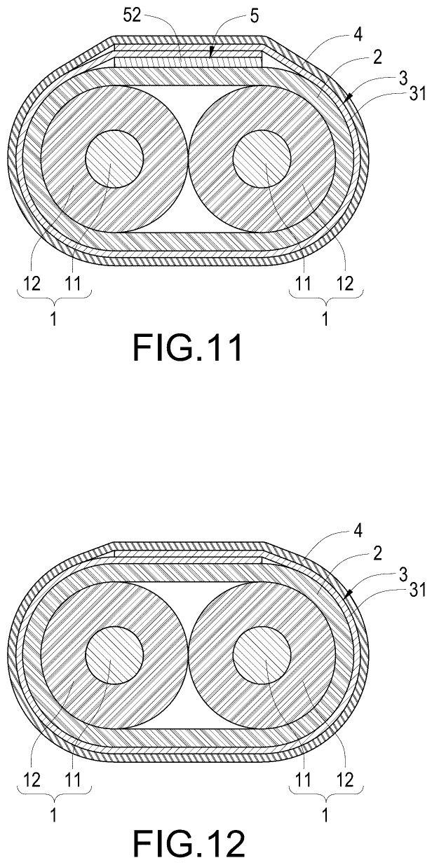

With reference to FIGS. 9 to 12 for the cable unit structure 10 in accordance with the fourth, fifth, sixth, and seventh embodiment of the present disclosure respectively, these embodiments are substantially the same as the first embodiment as shown in FIGS. 1 to 4, except that the drain wire 5 of these embodiments is a flat conductor 52 with a flat cross section.

Further detailed description is as follows: there is one drain wire 5 in the fourth embodiment, that is, there is one flat conductor 52 clamped between the inner shielding layer 3 and the outer cladding layer 4 and configured at the upper side of the two side-by-side cable cores 1; there are two drain wires 5 in the fifth embodiment, that is, there are two flat conductors 52, which are respectively clamped between the inner shielding layer 3 and the outer cladding layer 4 and configured at the upper and lower sides of the two side-by-side cable cores 1; there is one drain wire 5 in the sixth embodiment, that is, there is one flat conductor 52, which is clamped between the low dielectric material layer 2 and the inner shielding layer 3 and configured at the upper side of the two side-by-side cable cores 1, and the flat conductor 52 has a smaller volume that that of the cylindrical conductor 51 to facilitate reducing the wire diameter of the cable unit structure 10.

With reference to FIG. 12 for the cable unit structure 10 in accordance with the seventh embodiment of the present disclosure, this embodiment is substantially the same as the first embodiment as shown in FIGS. 1 to 4, except that there is no drain wire 5 in this embodiment, When the inner shielding layer 3 of the present embodiment is a composite shielding layer 31, the aluminum layer 314 is disposed at the outermost portion of the inner shielding layer 3 and sandwiched between the inner shielding layer 3 and the outer cladding layer 4, so that the aluminum layer 314 is directly grounded to replace the drain wire 5; similarly, when the inner shielding layer 3 is formed by one or more copper or aluminum layers, the copper or aluminum layer is also directly grounded to replace the drain wire 5.

What is claimed is:

1. A cable unit structure, comprising:
two cable cores, arranged parallel to each other, each of the cable core comprising an inner conductor and an insulation layer covering outside of the inner conductor;
a low dielectric material layer, wrapping around the two cable cores;
an inner shielding layer, covering the low dielectric material layer; and
an outer cladding layer, comprising an insulative adhesive layer and a copper or aluminum layer, the outer cladding layer covering the inner shielding layer in a crossover manner of the copper or aluminum layer being located inside and the insulative adhesive layer being located outside, and the insulative adhesive layer being formed by a heat-melt polyethylene terephthalate or polypropylene tape layer.

2. The cable unit structure according to claim 1, wherein the inner shielding layer is a composite shielding layer, the composite shielding layer covers the low dielectric material layer in a manner of concentrical wrapping and longitudinal covering, the composite shielding layer comprises a hot melt adhesive layer, a copper or aluminum layer, a conductive adhesive layer and an aluminum layer sequentially stacked in a direction away from the low dielectric material layer, and a longitudinal covering bandwidth of the composite shielding layer is equal to or greater than 40 GHz.

3. The cable unit structure according to claim 1, wherein the inner shielding layer is a copper or aluminum layer covers the low dielectric material layer in a manner of concentrical wrapping and longitudinal covering.

4. The cable unit structure according to claim 1, wherein the inner shielding layer comprises two copper or aluminum layers, one of the copper or aluminum layers covers the low dielectric material layer in a manner of concentrical wrapping and longitudinal covering, and another copper or aluminum layer covers the one of the copper or aluminum layers in a manner of wrapping.

5. The cable unit structure according to claim 1, wherein a cross-covering overlap rate of two layers with the copper or aluminum layer located inside and the insulative adhesive layer located outside is equal to or greater than 25%.

6. The cable unit structure according to claim 1, wherein a wrapping overlap rate of the low dielectric material layer is equal to or greater than 40% and equal to or less than 70%, and a thickness of the low dielectric material layer is equal to or greater than 0.02 mm and equal to or less than 0.12 mm.

7. The cable unit structure according to claim 1, further comprising at least one drain wire clamped between the inner shielding layer and the outer cladding layer, or clamped between the low dielectric material layer and the inner shielding layer, and the drain wire is a cylindrical conductor or a flat conductor.

8. The cable unit structure according to claim 1, wherein the low dielectric material layer is made of expanded polytetrafluoroethylene (ePTFE) or Polytetrafluoroethylene (PTFE).

9. A high-speed cable, comprising:
at least two cable unit structures arranged parallel to each other, each of the cable unit structures comprising:
two cable cores, arranged parallel to each other, each of the cable cores comprising an inner conductor and an insulation layer covering the inner conductor;
a low dielectric material layer, wrapping around the two cable cores;
an inner shielding layer, covering the low dielectric material layer; and
an outer cladding layer, comprising an insulative adhesive layer and a copper or aluminum layer, the outer cladding layer covering the inner shielding layer in a crossover manner of the copper or aluminum layer being located inside and the insulative adhesive layer being located outside, and the insulative adhesive layer is formed by a heat-melt polyethylene terephthalate or polypropylene tape layer.

10. The high-speed cable according to claim 9, wherein the inner shielding layer is a composite shielding layer, the composite shielding layer covers the low dielectric material layer in a manner of concentrical wrapping and longitudinal covering, the composite shielding layer comprises a hot melt adhesive layer, a copper or aluminum layer, a conductive adhesive layer and an aluminum layer sequentially stacked in a direction away from the low dielectric material layer, and a longitudinal covering bandwidth of the composite shielding layer is equal to or greater than 40 GHz.

11. The high-speed cable according to claim 9, wherein the inner shielding layer is a copper or aluminum layer covering the low dielectric material layer in a manner of concentrical wrapping and longitudinal covering.

12. The high-speed cable according to claim 9, wherein the inner shielding layer comprises two copper or aluminum layers, one of the copper or aluminum layers covers the low dielectric material layer in a manner of concentrical wrapping and longitudinal covering, and another copper or aluminum layer covers the one of the copper or aluminum layers in a manner of wrapping.

13. The high-speed cable according to claim 9, wherein a cross-covering overlap rate of two layers with the copper or aluminum layer located inside and the insulative adhesive layer located outside is equal to or greater than 25%.

14. The high-speed cable according to claim 9, wherein a wrapping overlap rate of the low dielectric material layer is equal to or greater than 40% and equal to or less than 70%, and a thickness of the low dielectric material layer is equal to or greater than 0.02 mm and equal to or less than 0.12 mm.

15. The high-speed cable according to claim 9, wherein each of the cable unit structures comprises at least one drain wire, the drain wire is clamped between the inner shielding layer and the outer cladding layer, or clamped between the low dielectric material layer and the inner shielding layer, and the drain wire is a cylindrical conductor or a flat conductor.

16. The high-speed cable according to claim 9, wherein the low dielectric material layer is made of expanded polytetrafluoroethylene (ePTFE) or Polytetrafluoroethylene (PTFE).

17. The high-speed cable according to claim 9, further comprising a first tape layer, an outer shielding layer, a braiding layer, an external layer and two spacers, wherein a quantity of the cable unit structures is two, the two cable unit structure are arranged at top and bottom relative to each other and parallel to each other, the first tape layer, the outer shielding layer, the braiding layer and the external layer sequentially wrap around the two cable unit structures from inside to outside, and the two spacers are clamped between the two cable unit structures and the first tape layer.

18. The high-speed cable according to claim 9, further comprising a first tape layer, a second tape layer, an outer shielding layer, a braiding layer, an external layer and two spacers, wherein a quantity of the cable unit structures is eight, two of the cable unit structures are arranged at top and bottom relative to each other and parallel to each other, the first tape layer wraps around two cable unit structures, and six cable unit structures equidistantly wrap around the two cable unit structures and the first tape layer, the second tape layer, the outer shielding layer, the braiding layer and the external layer sequentially wrap around eight cable unit structures from inside to outside, and the two spacers are clamped between the two cable unit structures and the first tape layer.
